(19) United States
(12) Patent Application Publication
(10) Pub. No.: US 2004/0011880 A1
(43) Pub. Date: Jan. 22, 2004

(54) Device that modifies irrigation schedules of existing irrigation controllers

(76) Inventors: John W Addink, Riverside, CA (US); Kirk Buhler, Corona, CA (US); Tony Givargis, Anaheim, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/343,350

(22) PCT Filed: Nov. 14, 2001
(86) PCT No.: PCT/US01/43500

(51) Int. Cl. B05D 1/00

(52) U.S. Cl. 239/1

(57) ABSTRACT

An irrigation control system in which a device (irrigation scheduler) automatically modifies irrigation schedules of installed irrigation controllers to affect irrigating of the landscape based on the water requirements of the landscape plants and comprises: an irrigation controller programmed to execute an irrigation schedule by closing an electrical circuit connecting the controller and a plurality of irrigation valves; and using an irrigation scheduler to: (a) monitor a plurality of control signals output by the irrigation controller by monitoring a current passing over a single common wire connecting the irrigation controller to the plurality of irrigation valves; and (b) selectively interrupt the circuit to execute an improved irrigation schedule. Preferably the microprocessor uses either an ETo value or weather data used in calculating the ETo value to at least partially derive the improved irrigation schedule.

### FIELD OF THE INVENTION

The field of the invention is irrigation controllers.

### BACKGROUND OF THE INVENTION

In arid areas of the world water is becoming one of the most precious natural resources. Meeting future water needs in these arid areas may require aggressive conservation measures. This requires irrigation systems that apply water to the landscape based on the water requirements of the plants. Many irrigation controllers have been developed for automatically controlling application of water to landscapes. Known irrigation controllers range from simple devices that control watering times based upon fixed schedules, to sophisticated devices that vary the watering schedules according to local geographic and climatic conditions.

With respect to the simpler types of irrigation controllers, a homeowner typically sets a watering schedule that involves specific run-times and days for each of a plurality of stations, and the controller executes the same schedule regardless of the season or weather conditions. From time to time the homeowner may manually adjust the watering schedule, but such adjustments are usually only made a few times during the year, and are based upon the homeowner's perceptions rather than actual watering needs. One change is often made in the late Spring when a portion of the yard becomes brown due to a lack of water. Another change is often made in the late Fall when the homeowner assumes that the vegetation does not require as much watering. These changes to the watering schedule are typically insufficient to achieve efficient watering.

More sophisticated irrigation controllers use evapotranspiration rates for determining the amount of water to be applied to a landscape. Evapotranspiration is the water lost by direct evaporation from the soil a plant and by transpiration from the plant surface. Potential evapotranspiration (ETo) can be calculated from meteorological data collected onsite, or from a similar site. One such system is discussed in U.S. Pat. No. 5,479,339 issued December, 1995, to Miller. Due to cost, most of the data for ETo calculations is gathered from off-site locations that are frequently operated by government agencies. Irrigation systems that use ETo data gathered from off-site locations are discussed in U.S. Pat. No. 5,023,787 issued June, 1991, and U.S. Pat. No. 5,229,937 issued July, 1993 both to Evelyn-Veere, U.S. Pat. No. 5,208,855, issued May, 1993, to Marian, U.S. Pat. No. 5,696,671, issued December, 1997, and U.S. Pat. No. 5,870,302, issued February, 1999, both to Oliver.

Due to cost and/or complicated operating requirements very few of these efficient irrigation controllers, discussed in the previous paragraph, are being installed on residential and small commercial landscape sites. Therefore, controllers that provide inadequate schedule modification primarily irrigate most residential and small commercial landscape sites. This results in either too much or too little water being applied to the landscape, which in turn results in both inefficient use of water and unnecessary stress on the plants. Therefore, a need existed for a cost-effective irrigation system for residential and small commercial landscape sites that is capable of frequently varying the irrigation schedule based upon estimates of actual water requirements. This need was met by U.S. Pat. No. 6,102,061, issued August, 2000 to Addink. However, there are thousands of manual irrigation controllers that have already been installed and are still being sold. Adjustments to these manual irrigation controllers are usually only made a few times during the year. The adjustments are based upon the homeowner's perceptions rather than actual watering needs of the landscape.

There are devices that can be connected to existing irrigation systems that will make automatic adjustments to the irrigation schedule but most of these interrupt or prevent one or more complete irrigation schedules from occurring. Examples of devices that interrupt or prevent the occurrence of planned irrigation schedules are rain sensors discussed in U.S. Pat. No. 4,613,764, issued September, 1986 to Lobato, U.S. Pat. No. 5,312,578, issued June, 1994 to Morrison et. al., U.S. Pat. No. 5,355,122 issued October, 1994 to Erickson, and U.S. Pat. No. 5,101,083, issued March, 1992 to Tyler, et al. There are other reasons for interrupting an irrigation schedule, such as; temperature extremes, high light intensity, high winds, and high humidity of which one or more of these are discussed in U.S. Pat. No. 5,839,660, issued November, 1998 to Morgenstern, et al., U.S. Pat. No. 5,853,122, issued December, 1998 to Caprio, U.S. Pat. No. 4,333,490 issued June, 1982 to Enter, SR., and U.S. Pat. No. 6,076,740, issued June, 2000 to Townsend. Additionally, there are patents that discuss the use of soil moisture sensors to control irrigation systems including U.S. Pat. No. 5,341,83 1, issued August, 1994 to Zur, U.S. Pat. No. 4,922,433, issued May, 1990 to Mark and U.S. Pat. No. 4,684,920 issued, August, 1987 to Reiter. However, as mentioned above, most of these devices, interrupt the operation of one or more full irrigation schedules or, as with the three above patents, rely on soil moisture sensors to control the irrigation applications. The disadvantage of soil moisture sensors is that the placement of the sensor(s) is critical to correct irrigation.

What is needed is a cost effective device that will automatically modify the run-times of the irrigation schedules of installed irrigation controllers to affect irrigating of the landscape to meet the water requirements of the landscape plants based on some method or device other than a soil sensor.

### SUMMARY OF THE INVENTION

The present invention provides an irrigation control system in which a device (irrigation scheduler) automatically modifies irrigation schedules of installed irrigation controllers to affect irrigating of the landscape based on the water requirements of the landscape plants and comprises: an irrigation controller programmed to execute an irrigation schedule by closing an electrical circuit connecting the controller and a plurality of irrigation valves; and using an irrigation scheduler to: (a) monitor a plurality of control signals output by the irrigation controller by monitoring a current passing over a single common wire connecting the irrigation controller to the plurality of irrigation valves; and (b) selectively interrupt the circuit to execute an improved irrigation schedule.

Preferably the monitor step comprises detecting at least some of the plurality of control signals over a period of one week. Alternatively, the monitor step may comprise detecting at least some of the plurality of control signals over a period other than one week, such as one day, two days, and so forth.

In a preferred embodiment of the present invention the monitor step comprises a microprocessor disposed in the irrigation scheduler, and the irrigation scheduler is not an integral part of the irrigation controller.

Additionally the microprocessor, disposed in the irrigation scheduler, takes part in determining the run-time minutes of multiple irrigation stations that are controlled by the irrigation controller. Preferably the determination of run-time minutes is of run-time minutes of each irrigation station. Alternatively, the determination of run-time minutes is of the total run-time minutes of all irrigation stations or an irrigation cycle. The microprocessor uses a switching circuit to cause interference with the valve reception of the control signals output by the irrigation controller. The output is an electrical signal that controls the opening and closing of the plurality of irrigation valves.

Preferably the microprocessor uses either an ETo value or weather data used in calculating the ETo value to at least partially derive the improved irrigation schedule. The weather data is from at least one of the following; temperature, humidity, solar radiation and wind.

The ETo value may be a current ETo value, an estimated ETo value or an historical ETo value.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic of an irrigation scheduler.

FIG. 2 is a schematic of an irrigation controller.

FIG. 3 is a block diagram of an automatic irrigation system with an irrigation scheduler according to an aspect of the present invention.

FIG. 4 is data that illustrates a derivation of an improved irrigation schedule by a microprocessor disposed in an irrigation scheduler.

FIG. 5 is data that illustrates an alternative derivation of an improved irrigation schedule by a microprocessor disposed in an irrigation scheduler.

### DETAILED DESCRIPTION

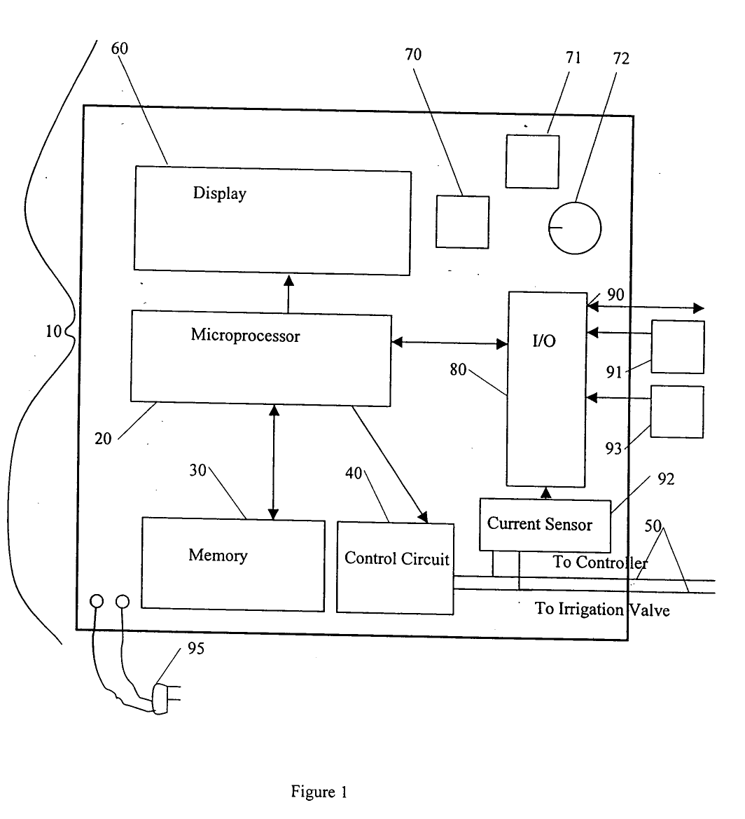

Referring to FIG. 1, the irrigation scheduler 10 according to the present invention includes a microprocessor 20, an on-board memory 30, a switching circuit 40, a display 60, some manual input devices 70 through 72 (knobs and/or buttons), an input/output (I/O) circuitry 80 connected in a conventional manner, a communications port 90, a rain sensor 91, a current sensor 92, a temperature sensor 93, and a power supply 95. Each of these components by itself is well known in the electronic industry, with the exception of the programming of the microprocessor in accordance with the functionality set forth herein. There are hundreds of suitable chips that can be used for this purpose. At present, experimental versions have been made using a generic Intel 80C54 chip, and it is contemplated that such a chip would be satisfactory for production models.

In a preferred embodiment of the present invention the irrigation scheduler has one or more common communication internal bus(es). The bus can use a common or custom protocol to communicate between devices. There are several suitable communication protocols, which can be used for this purpose. At present, experimental versions have been made using an I²C serial data communication, and it is contemplated that this communication method would be satisfactory for production models. This bus is used for internal data transfer to and from the EEPROM memory, and is used for communication with personal computers, peripheral devices, and measurement equipment including but not limited to rain sensors, water pressure sensors, and temperature sensors.

The switching circuit 40 is preferably an electrical switching circuit. The electrical switching circuit may be of various standard types that are well known in the art and therefore are not described in detail here.

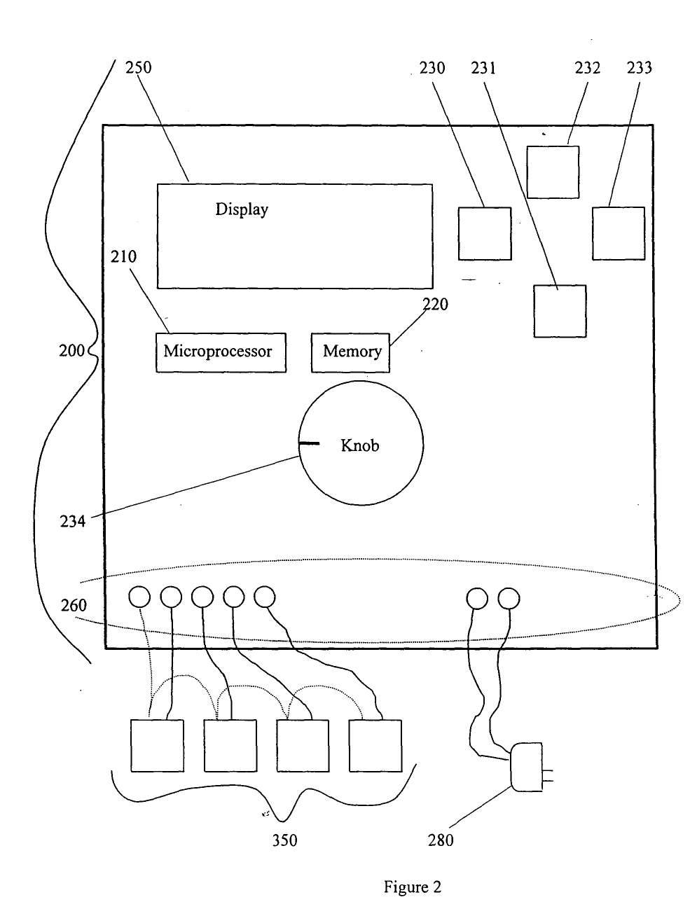

Referring to FIG. 2, an irrigation controller 200 according to the present invention generally includes a microprocessor 210, an on-board memory 220, some manual input devices 230 through 234 (buttons and/or knobs), a display screen 250, electrical connectors 260, which are connected to a plurality of valves 350, and a power supply 280. Each of these components by itself is well known in the electronic industry.

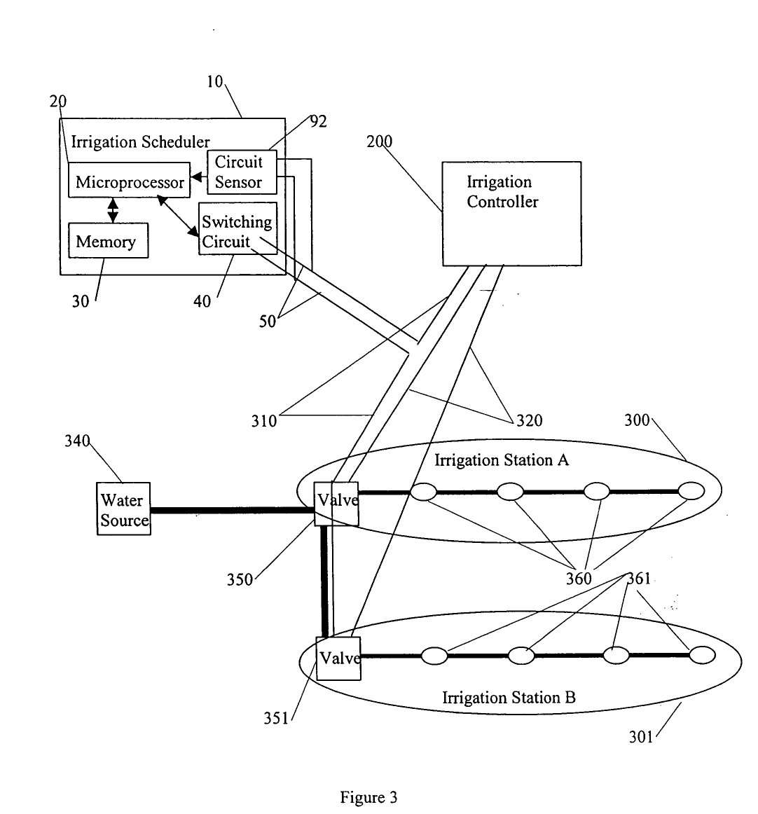

Referring to FIG. 3, the switching circuit 40, disposed in the irrigation scheduler, provides an electrical connection 50 in series with the common return wire 310 from the plurality of valves 350 and 351 to the controller 200. Also, the circuit sensor 92 is connected to the common wire 310 through the electrical connection 50. Alternatively, it could be connected directly to the common wire 310 by electrical connections from the current sensor to the common wire 310. From the controller 200 parallel electrical control wires 320 go to each irrigation valve 350 and 351.

In a preferred embodiment of the present invention the irrigation scheduler 10 is not an integral part of the irrigation controller 200. The term integral as used herein means that the irrigation scheduler 10 is a separate device from the irrigation controller 200.

When the irrigation controller 200 actuates the opening and closing of the irrigation valves 350 and 351 there is an output generated. In a preferred embodiment of the present invention the output is electrical signals. When power is first applied to a solenoid the starting current is about 0.35 amps. The holding current is 0.25 amps. Therefore, because of the difference between the starting and holding current, the microprocessor can learn when each valve is opened and closed. However, it is contemplated that the output could be something other than electrical signals. The electrical signals are transmitted through the common wire 310 to the current sensor 92 via the electrical connection 50. The microprocessor 20, disposed in the irrigation scheduler 10, is connected to the current sensor 92 and receives the electrical signals. Based on the electrical signals that are generated, the microprocessor 20 can learn the start time and run-time minutes of each of the irrigation stations A 300 and B 301 (Although, only two stations are shown the irrigation controller will generally control more than two stations).

Alternatively, the microprocessor 20 derives the start time and completion time or run-time minutes of an irrigation cycle. The term irrigation cycle describes the entire time period from when the irrigation controller turns on the first station to when the last station completes its irrigation application. There may be one or more irrigation cycles during each day. For example, the irrigation controller 200 could execute irrigation stations A 300 and B 301 in the early morning and only irrigation station A 300 in the evening. The first irrigation cycle would include stations A 300 and B 301 in the morning and the second irrigation cycle would involve only station A 300 in the evening.

In a preferred embodiment of the present invention the irrigation controller 200 is set to affect an irrigation schedule that would be used during the summer months. This irrigation schedule should then provide the highest quantity of water that would be required to maintain the landscape plants in a healthy condition during the driest part of the year. Preferably the irrigation scheduler 10 will monitor the irrigation schedule for a period of seven days to learn the start times and run-time minutes for each station or for each irrigation cycle. However, the period can be more or less than seven days. The microprocessor 20, disposed in the irrigation scheduler 10, watches and learns when the valves are opened and closed, which would represent the start times and run-time minutes for each irrigation station A 300 and B 301. Alternatively, the microprocessor 20 watches and learns when the first valve opens and when the last valve closes or the irrigation cycle of irrigation stations A 300 and B 301. This information (first set of information) is then stored in the memory.

Should the settings on the irrigation controller ever be changed the microprocessor 20, disposed in the irrigation scheduler 10, will discern that the settings were changed and will watch and learn the new start times and run-time minutes for irrigation stations A 300 and B 301 or the start times and run-time minutes for an irrigation cycle of stations A 300 and B 301. However, preferably the irrigation schedule, modified by the change in the irrigation controller settings, has to be repeated before the microprocessor 20 will make any changes to the run-time minutes of the improved irrigation schedule. This permits the irrigation user to test the irrigation system or to add an additional watering without affecting the run-time minutes of the improved irrigation schedule executed by the microprocessor 20 disposed in the irrigation scheduler 10.

Referring again to FIG. 3, after the microprocessor 20 derives the start times and run-time minutes for irrigation stations A 300 and B 301Or the start times and run-times for the irrigation cycle of stations A 300 and B 301, the microprocessor 20 will use this information with a second set of information to control the run-time minutes of the improved irrigation schedule. The second set of information includes either an ETo value or weather data used in calculating the ETo value. The second set of information is received and used by the microprocessor 20 to at least partially derive the improved irrigation schedule. The weather data, used in calculating the ETo value, is from at least one of the following; temperature, humidity, solar radiation and wind. Additionally, the ETo value may be a current ETo value, an estimated ETo value or an historical ETo value.

It is contemplated that the ETo value or weather data used in calculating the ETo value will be received by the microprocessor 20 through the communications port 90, FIG. 1 over the network and preferably via the Internet. However, the ETo value or weather data used in calculating the ETo value may be received via a telephone line, radio, pager, two-way pager, cable, and any other suitable communication mechanism. It is also contemplated that the microprocessor 20 may receive the weather data, used in calculating the ETo value, directly from sensors, such as the temperature sensor 93, FIG. 1, at the irrigation site. The ETo value, from which at least partly the improved irrigation schedule is derived, is preferably a current ETo value, where the term “current” is used to mean within the last two weeks. It is more preferred, however, that the current weather information is from the most recent few days, and even more preferably from the current day. Regardless, ETo values may be potential ETo values received by the microprocessor 20 or estimated ETo values derived from weather data received by the microprocessor 20. The ETo value may also be a historic ETo value that is stored in the memory 30 of the irrigation scheduler 10.

The second set of information, received by the microprocessor 20, may include, in addition to ETo values, other meteorological, environmental, geographical and irrigation design factors that influence the water requirements of landscape plants and/or influence the quantity of water applied, such as, rain values, crop coefficient values and irrigation distribution uniformity values.

The microprocessor 20, using the first and second set of information, affects the opening and closing of the switching circuit 40. The opening and closing of the switching circuit affects the actuation of the valves 350 and 351 by the irrigation controller 200. When the switching circuit 40 is open there is no electrical connection between the irrigation controller 200 and the valves 350 and 351 and the valves 350 and 351 will remain closed. When the switching circuit 40 is closed there is an electrical connection between the irrigation controller 200 and the valves 350 and 351. When there is an electrical connection between the irrigation controller 200 and the valves 350 and 351 the irrigation controller 200 can control when the valves 350 and 351 are opened and closed. Therefore, the microprocessor 20 first learns the start times and run-times of the irrigation stations, which is the first set of information. Then, the microprocessor 20 derives an improved irrigation schedule from the second set of information the microprocessor 20 receives. The microprocessor 20 then uses the first set of information and the second set of information to control the opening and closing of the switching circuit 40, which controls the run-time minutes of the irrigation stations A 300 and B 301.

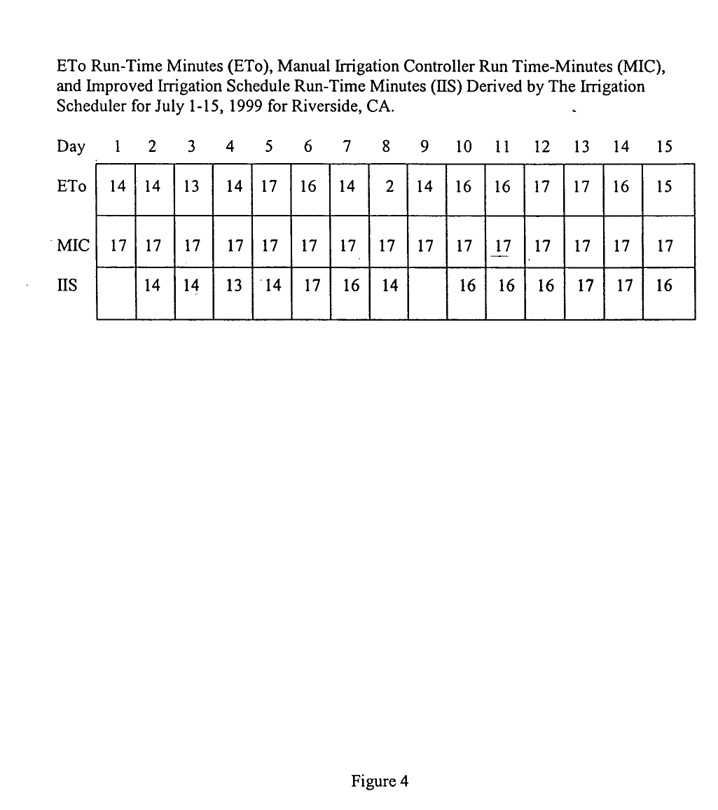

FIG. 4 is data that illustrates a derivation of an improved irrigation schedule by a microprocessor disposed in an irrigation scheduler. The second set of information, received by the microprocessor 20, FIG. 3, is actual ETo values from Riverside, Calif. for the period from July 1 to Jul. 15, 1999 and this data is listed in the ETo row of FIG. 4. ETo data is generally provided in inches per day that is then converted to run-time minutes by the irrigation scheduler. Therefore in this example, the ETo values in FIG. 4 were converted to run-time minutes based on an application rate of one inch of water being applied per 60 minutes of irrigation application time. Although, the following data uses run-time minutes, it should be appreciated that inches of water or any other designation that reflects the amount of water to be applied to an irrigated area may be used. It was assumed, in this example, that the maximum summer run-time minutes for the site, where the irrigation controller is located, is 17 minutes per day, which will be the run-time minute setting of the manual irrigation controller and is listed in the MIC row of FIG. 4. Further, the assumption was made that the start time for the irrigation application is at 6:00 a.m. The irrigation scheduler 20, FIG. 3 monitors the start times and run-time minutes for each station A 300 and B 301 and stores this information in the memory 30. On July 1, the ETo value was 14 run-time minutes, which would be the preferred run-time minutes for an irrigation application on the following day or on July 2 (Applications are based on the previous day or days ETo values). Therefore, the microprocessor 20 receives the ETo value and converts it into 14 run-time minutes. The microprocessor 20 learned the start time and run-time minutes of the irrigation stations and interferes with the reception of the output from the irrigation controller to the valves, so that 14 minutes of watering will be applied by each irrigation station A 300 and B 301, FIG. 3. These 14 minutes are the run-time minutes of the improved irrigation schedule and are listed in row IIS under day 2, FIG. 4.

Referring again to FIG. 3, the microprocessor 20 will affect the switching circuit 40 to be in the closed position when the irrigation controller 200 actuates the valve 350 of Station A 300 at 6:00 a.m. With the switching circuit 40 in the closed position, when the valve is actuated water will flow through the valve 350 from the water source 340 to irrigate the landscape through the sprinkler heads 360. After 14 minutes, the microprocessor 20 will affect the switching circuit 40 to be in the open position, which breaks the electrical connection between the irrigation controller 200 and the valve 350 resulting in the closing of the valve 350 of Station A 300. Since the manual irrigation controller is set to operate each valve for 17 minutes, during the last next 3 minutes of the 17 minutes, neither station, A 300 or B 301, will be irrigating. Then the irrigation controller 200 will actuate the valve to Station B 301. The irrigation scheduler 10 will allow the valve 350 of Station B 301 to remain open for 14 minutes, at which time the switching circuit will be activated to be in the open position. This will break the electrical connection between the irrigation controller 200 and the valve 351 resulting in the closing of the valve 351 of Station B 301. Therefore, in a preferred embodiment of the present invention each station will apply an improved irrigation schedule of 14 minutes of water to the landscape rather than 17 minutes of water, which would have been applied based on the setting of the manual irrigation controller. Based on the ETo value, if 17 minutes of water were applied to the landscape, there would have been excessive water applied to the landscape.

The process mentioned in the previous paragraph for July 2 would occur each day from July 3 to July 15. The microprocessor 20 would receive ETo values and then derive an improved irrigation schedule based on the ETo values received. This improved irrigation schedule would then be applied in the next scheduled irrigation application. However, it is contemplated that on July 9 there will not be an irrigation application as indicated by the absence of any run-time minutes for day 9 in row IIS of FIG. 4. In a preferred embodiment of the present invention, the microprocessor 20 is programmed to accumulate watering amounts should the watering amounts be less than a certain minimum amount (See U. S. application Ser. No. 09/478108). This provides for deep watering of the soil, which enhances deep root growth It is further contemplated, that if the irrigation user only waters every other day, then the microprocessor 20 is programmed to accumulate the required amount of water that would have been applied on a daily basis so that the proper amount is applied every other day or at any interval the user may have their manual irrigation controller 300 set to affect an irrigation application.

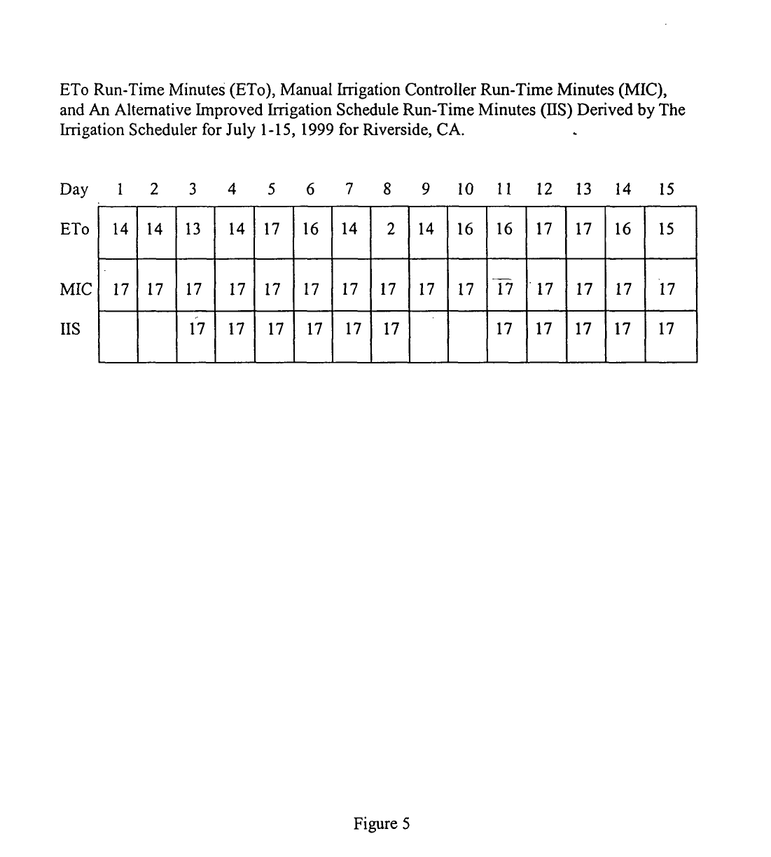

FIG. 5 is data that illustrates an alternative derivation of an improved irrigation schedule by a microprocessor disposed in an irrigation scheduler. The second set of information is the same as above or actual ETo values from July 1 to Jul. 15, 1999 are from Riverside, Calif. Further, the maximum summer run-time minutes setting for the manual irrigation controller is 17 minutes. As mentioned above, the start time will again be assumed to be 6:00 a.m. Further, assume that the manual irrigation controller is set to water every day. Additionally, the irrigation scheduler 10 is programmed so that an irrigation application will not be applied unless the full 17 minute manual irrigation controller run-time setting will be applied by each station. The switching circuit 40 will remain in the open position interfering with the electrical connection between the irrigation controller and the valves during the entire irrigation cycle if the irrigation run-time minutes to be applied by each station would be less than the full 17 minute manual irrigation run time setting. The microprocessor 20, FIG. 1 learns the start times and run-times of an irrigation cycle that is executed by the manual irrigation controller. The microprocessor 20 uses this information to control the start times and length of time that the switching circuit 40 will be in the closed and open position.

Referring again to FIG. 5, on July 1, the actual ETo run-time minutes are 14 minutes. Therefore, since there are only 14 run-time minutes on July 1, which is less than the full 17 minute manual irrigation controller run-time setting, there will not be an irrigation application on July 2 (As mentioned above, applications are based on the previous day or days ETo values). The 14 minutes of run-time will be carried over to the next application. On July 2, the ETo value is again 14 run-time minutes. The total accumulated run-time minutes for July 1 and July 2 are 28 run-time minutes (14+14=28), which exceeds the full 17 minute manual irrigation controller run-time setting. Therefore, on July 3, a full 17 minutes of water will be applied by each station A 300 and B 301, FIG. 3 to the landscape (IIS row, day 3). There will be a carryover of 11 run-time minutes to the next application (28−17=11). The actual ETo value for July 3 is 13 run-time minutes plus the carryover of 11 minutes, which gives an accumulated run-time minutes of 24 minutes. Therefore, on July 4 there will be another application of 17 minutes with a carryover of 7 minutes. A similar process, as described above, was used to determine the irrigation applications for the period from July 5 to July 15 (Row IIS). In conclusion, the ETo run-time minutes are accumulated until they are equal to or greater than the manual irrigation controller setting and then an application is made that is equal to the full 17 minute run-time setting. Any run-time minutes in excess of the full run-time minutes will be carried over to the next application. On July 9 and 10 the accumulated run-time minutes were less than the full 17 minute run-time setting and therefore no irrigation applications were made on those days, as indicated by the absence of numbers in the IIS row on day 9 and 10.

It is contemplated that with the alternative derivation of the improved irrigation schedules, that on the days when the irrigation scheduler 10 prevents the irrigation controller from executing an irrigation schedule to the landscape, it will only prevent the execution during the hours when the irrigation scheduler 10 has learned that an irrigation cycle would have been executed by the irrigation controller. For example, with the above listed setting for the irrigation controller, the irrigation cycle would have occurred from 6:00 a.m. to 6:34 a.m. for stations A 300 and B 301 (17 minutes+17 minutes=34 minutes). The irrigation scheduler 10, during the monitoring step, has learned that the irrigation cycle started at 6:00 a.m. and was for a total run-time of 34 minutes. Therefore, on the days when the irrigation scheduler 10 prevents irrigations from occurring it will only prevent irrigations from occurring between 6:00 a.m. and 6:34 a.m. This allows the irrigation user to manually set the controller to water the landscape during time periods other than between 6:00 a.m. to 6:34 a.m. Additionally, the irrigation scheduler 10 can be turned off and the irrigation controller 200 will provide complete control of the irrigating of the landscape with no interference by the irrigation scheduler of the irrigation applications.

The above examples, of the microprocessor 20, FIG. 2 derivations of improved irrigation schedules from a second set of received information, were based only on received ETo values. However as mentioned previously, the second set of information, received by the microprocessor 20 may include additional meteorological, environmental, geographical and irrigation design factors that influence the water requirements of landscape plants and/or influence the quantity of water applied, such as, rain values, crop coefficient values and irrigation distribution uniformity values.

Thus, specific embodiments and applications of the Irrigation scheduler have been disclosed. It should be apparent, however, to those skilled in the art that many more modifications besides those described are possible without departing from the inventive concepts herein. The inventive subject matter, therefore, is not to be restricted except in the spirit of the appended claim.

What is claimed is:

1. A method of controlling irrigation, comprising:
providing an irrigation controller programmed to execute an irrigation schedule by closing an electrical circuit connecting the controller and a plurality of irrigation valves;
an irrigation scheduler monitoring a plurality of control signals output by the irrigation controller by analyzing a current passing over a common wire connecting the irrigation controller to the plurality of irrigation valves; and
the irrigation scheduler selectively interrupting the electrical circuit to execute an improved irrigation schedule.

2. The method of claim 1, wherein the step of monitoring comprises detecting at least some of the plurality of control signals over a period of one week.

3. The method of claim 1, wherein the step of monitoring comprises a microprocessor external to the irrigation controller at least partially determining run-time minutes of multiple irrigation stations that are controlled by the irrigation controller.

4. The method of claim 3, wherein the run-time minutes of the multiple irrigation stations comprise at least one of run-time minutes of each irrigation station and total run-time minutes of all irrigation stations.

5. The method of claim 1, further comprising the step of using at least one of an ETo value and a weather data used in calculating the ETo value to at least partially derive the improved irrigation schedule.

6. The method of claim 5, wherein the weather data is at least one of temperature, humidity, solar radiation, and wind.

7. The method of claim 1, wherein the step of monitoring comprises a microprocessor external to the irrigation controller at least partially determining run-time minutes of multiple stations being executed by the irrigation controller over a period of at least one week; and
further comprising the microprocessor using at least one of an ETo value and a weather data used in calculating the ETo value to at least partially derive the improved irrigation schedule.

8. An irrigation scheduler, that cooperates with an irrigation controller having an electrical circuit that extends from the controller to a plurality of irrigation valves, comprising
a microprocessor programmed to:
derive a first set of information from a plurality of control signals output by the irrigation controller to the plurality of irrigation valves;
receive a second set of information comprising at least one of an ETo value and a weather data used in calculating the ETo value; and
use the first set of information and the second set of information to interrupt the electrical circuit.

9. The irrigation scheduler of claim 8, wherein the microprocessor is disposed in the irrigation scheduler, and the irrigation scheduler is not an integral part of the irrigation controller.

10. The irrigation scheduler of claim 8, further comprising a switching circuit used by the microprocessor to interrupt the electrical circuit.

11. The irrigation scheduler of claim 8, wherein the plurality of control signals comprises an electrical signal that controls opening and closing of the plurality of irrigation valves.

12. The irrigation scheduler of claim 8, wherein the microprocessor is further programmed to at least in part control run-time minutes of the plurality of irrigation valves as a function of the plurality of control signals.

13. The irrigation scheduler of claim 8, wherein the weather data is at least one of temperature, humidity, solar radiation, and wind.

14. The irrigation scheduler of claim 8, wherein the ETo value comprises a current ETo value.

15. The irrigation scheduler of claim 8, wherein the ETo value comprises an estimated ETo value.

16. The irrigation scheduler of claim 8, wherein the ETo value comprises an historical ETo value.
